(19) United States
(12) Patent Application Publication
(10) Pub. No.: US 2018/0315189 A1
(43) Pub. Date: Nov. 1, 2018

(54) INFORMATION PROCESSING APPARATUS, INFORMATION PROCESSING METHOD, AND NON-TRANSITORY COMPUTER-READABLE STORAGE MEDIUM

(71) Applicant: CANON KABUSHIKI KAISHA, Tokyo (JP)

(72) Inventor: Takaaki Endo, Urayasu-shi (JP)

(21) Appl. No.: 15/960,846

(22) Filed: Apr. 24, 2018

(30) Foreign Application Priority Data
Apr. 26, 2017 (JP) 2017-087591

(51) Int. Cl. G06T 7/00

(52) U.S. Cl. CPC G06T 7/0012; G06T 7/97; G06T 2207/30068; G06T 2207/30101; G06T 2207/10132; G06T 2207/10084

(57) ABSTRACT

An information processing apparatus obtains one or more images that are imaged by scanning region of a subject with an imaging device, analyzes the obtained one or more images to extract a predetermined structure, and determines whether the region is on the left or right of the subject based on information relating to a shape or position of the extracted structure in the obtained one or more images.

### BACKGROUND OF THE INVENTION

### Field of the Invention

The present invention relates to an information processing apparatus, an information processing method, and a non-transitory computer-readable storage medium.

### Description of the Related Art

At a medical site, a doctor performs a diagnosis by using medical images imaged by various modalities (imaging apparatuses) such as an ultrasonic diagnosis apparatus, a photoacoustic tomography apparatus (hereinafter referred to as a PAT apparatus), a magnetic resonance imaging apparatus (hereinafter referred to as an MRI apparatus), a computed tomography apparatus (hereinafter referred to as an X-ray CT apparatus), and an optical coherence tomography apparatus (hereinafter referred to as an OCT apparatus). In such a case, determining, based on information relating to the medical image, what organ (region) of a subject was imaged to produce the medical image, or which one of left and right organs was imaged is useful and various conventional methods have been proposed.

For example, Japanese Patent Laid-Open No. 2009-131319 recites a method for determining an organ where a capsule type endoscope is positioned at a time of imaging an in vivo image, based on a feature amount of the in vivo image imaged by the capsule type endoscope. Here, a file size of an in vivo image that has been compression encoded or a DCT coefficient calculated when an in vivo image that has been DCT (discrete cosine transformation) encoded is decoded is used as a feature amount of the in vivo image. In addition, Japanese Patent No. 5284123 recites a method for calculating motion information from a time series ultrasonic image group, and determining left or right of an organ for which an operation by an ultrasonic probe was performed from an intensity ratio between a motion component in the motion information originating in a heart beat, and a motion component originating in respiration.

However, the method recited in Japanese Patent Laid-Open No. 2009-131319 has a problem in that, in the case of a pair of left and right organs (regions), determining left or right for an organ is not possible because no difference in feature amount occurs in an image. In contrast, the method recited in Japanese Patent No. 5284123 has the problem that fixing the ultrasonic probe for obtaining the time series images to a predetermined position for predetermined amount of time is necessary, and the procedure for determining a left or right organ is complicated.

### SUMMARY OF THE INVENTION

The present disclosure provides a mechanism for easily determining whether an imaged region is a left or right organ, in order to solve the problems described above.

According to one aspect of the present invention, there is provided an information processing apparatus which comprises: an obtaining unit configured to obtain one or more images that are imaged by scanning region of a subject with an imaging device; an analysis unit configured to analyze the obtained one or more images to extract a predetermined structure; and a determination unit configured to determine whether the region is on the left or right of the subject based on information relating to a shape or position of the extracted structure in the obtained one or more images.

Further features of the present invention will become apparent from the following description of exemplary embodiments (with reference to the attached drawings).

### BRIEF DESCRIPTION OF THE DRAWINGS

FIG. 1 illustrates a functional configuration of an information processing apparatus in a first embodiment.

FIG. 2 schematically illustrates an imaging device and organs of a subject, in the first embodiment.

FIG. 3 illustrates a captured image in the first embodiment.

FIG. 4 illustrates an example of a hardware configuration of the information processing apparatus in the first embodiment.

FIG. 5 is a flowchart for illustrating a processing procedure of the information processing apparatus in the first embodiment.

FIG. 6 illustrates a backbone structure in the first embodiment.

FIG. 7 is a flowchart for illustrating a procedure for determination processing in the first embodiment.

FIG. 8 schematically illustrates an imaging device and organs of a subject, in a second embodiment.

FIG. 9 is a flowchart for illustrating a processing procedure of the information processing apparatus in the second embodiment.

FIG. 10 illustrates a functional configuration of an information processing apparatus in a third embodiment.

FIG. 11 is a flowchart for illustrating a processing procedure of the information processing apparatus in the third embodiment.

### DESCRIPTION OF THE EMBODIMENTS

Detailed description is given below regarding embodiments of the present invention while referring to the attached drawings. However, the scope of the present invention is not limited to the examples that are shown.

### First Embodiment

An information processing apparatus in the first embodiment extracts a predetermined structure from a series of images obtained (imaged) by scanning an organ (a region) of a subject with an imaging device, and determines left or right for the organ based on information (a position or a change of shape) relating to a position or shape in images of the extracted structure. In the present embodiment, description is given by taking as an example a case where the organ of a subject is a breast, an imaging device for imaging the series of images is a one-dimensional array probe (hereinafter referred to as a 1D probe) of an ultrasonic diagnosis apparatus, and a rib is extracted as the predetermined structure from the series of images which are saved on a data server. Note that, in the following description, it is assumed that a direction regarding an operation (scanning) that uses the 1D probe or the like by an examiner is a direction with respect to a body of subject seen from an examiner side.

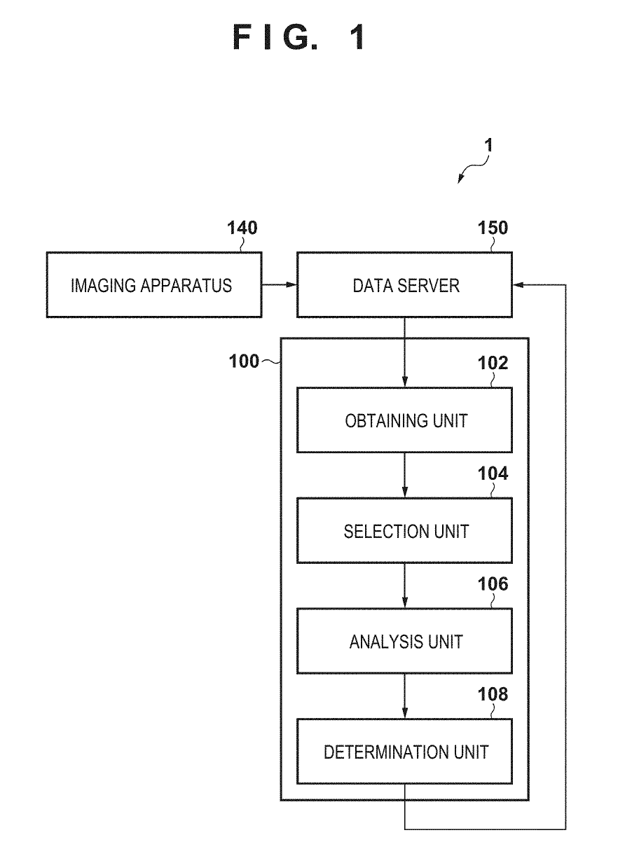

FIG. 1 is a view illustrating an example of a functional configuration of an information processing apparatus in the first embodiment. An information processing apparatus in the first embodiment is an information processing apparatus 100 which is illustrated in FIG. 1. An information processing system 1 in the first embodiment has the information processing apparatus 100, an imaging apparatus 140, and a data server 150.

The imaging apparatus 140 is an ultrasonic diagnosis apparatus for example, and images a series of tomographic images of a breast in accordance with a manual scan of the 1D probe by an operator. The series of tomographic images can include at least a part of left and right breasts. Here, it is assumed that a manual scan of the 1D probe is performed by the operator in accordance with a predetermined procedure. In the present embodiment, as an example, it is assumed that an operator performs a longitudinal scan of a 1D probe 240 in a vertical direction in a horizontal section with a top-right of a breast (in other words the top-right of the breast of subject seen from the examiner side) as an origin, and then performs a transverse scan in a left-and-right direction in a sagittal section with the top-right of the breast as an origin. However, an implementation of the present invention is not limited to this, and configuration may be taken to have scanning by a predetermined procedure, and for example the operator may perform a longitudinal scan of the 1D probe 240 after performing a transverse scan.

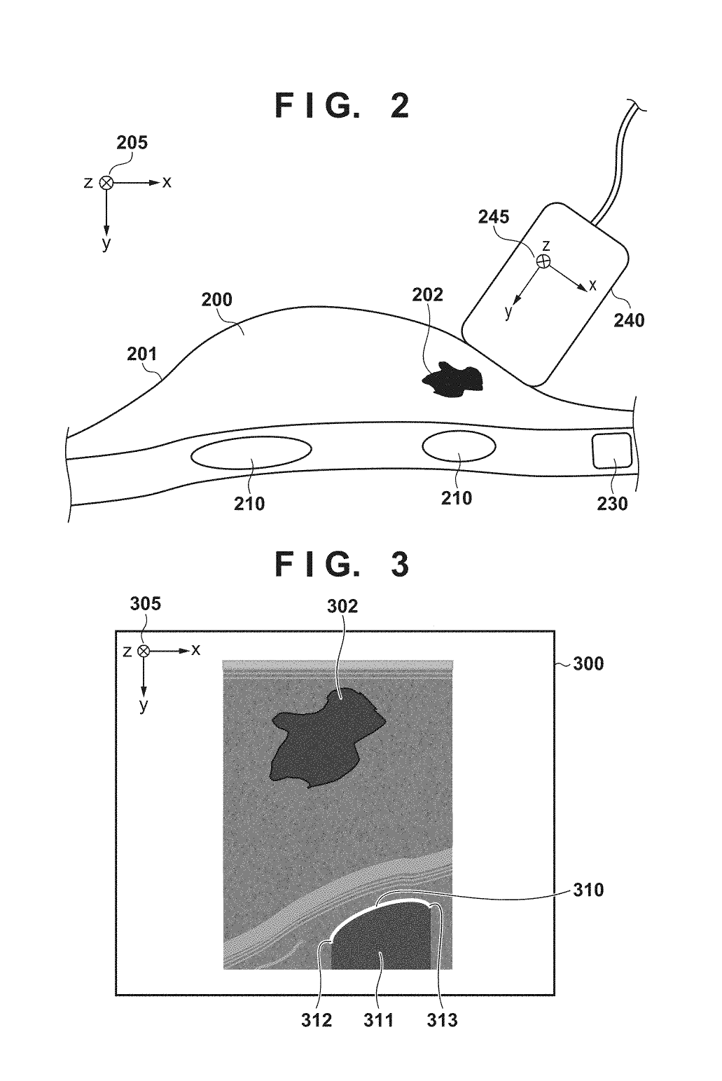

FIG. 2 is a view of a horizontal section that illustrates a situation where an operator scans the 1D probe 240 following skin 201 (in other words, a surface) of a breast 200 that is on a left side of a subject (a breast that is on a right side of subject seen from an examiner side). In FIG. 2 the 1D probe 240 is at a top-right (near an armpit) origin position, and ribs 210 are present in a direction in which an ultrasonic beam is transmitted from the 1D probe 240 (a positive direction in a Y axis of an ultrasonic wave coordinate system 245). In addition, a breastbone 230 is also present.

The data server 150 holds a series of tomographic images of the breast that was imaged by the imaging apparatus 140.

The information processing apparatus 100 has an obtaining unit 102, a selection unit 104, an analysis unit 106, and a determination unit 108. The obtaining unit 102 obtains the series of tomographic images of the breast from the data server 150. The selection unit 104 selects a tomographic image group to use in extraction of a predetermined structure (a rib in the present embodiment) from the series of tomographic images of the breast. The analysis unit 106 analyzes the selected tomographic image group, and extracts a position of the predetermined structure in each tomographic image. The determination unit 108 determines left or right of the breast for the subject, based on the position of the predetermined structure in each tomographic image.

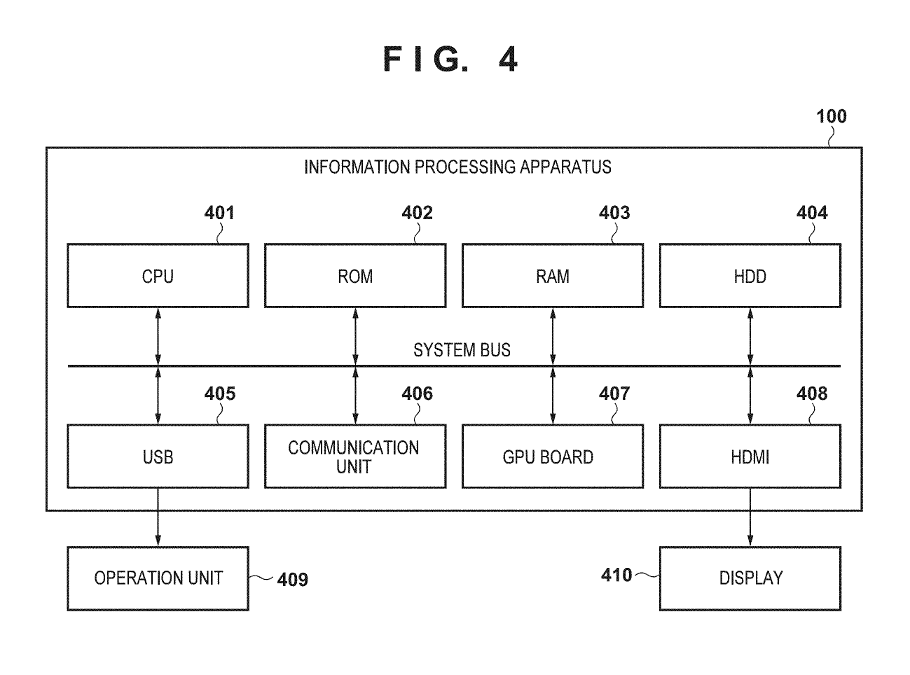

FIG. 4 is an view that illustrates an example of a hardware configuration of the information processing apparatus 100. As an example, the information processing apparatus 100 has a CPU 401, a ROM 402, a RAM 403, an HDD 404, a USB 405, a communication unit 406, a GPU board 407, and a HDMI 408. These are communicably connected by an internal bus.

The CPU (Central Processing Unit) 401 is a control circuit for comprehensively controlling the information processing apparatus 100 and each unit connected to the CPU 401. The CPU 401 implements control by executing a program stored in the ROM 402. In addition, the CPU 401 executes a display driver, which is software for controlling a display 410, to perform display control with respect to the display 410. Furthermore, the CPU 401 performs input/output control with respect to an operation unit 409.

The ROM (Read Only Memory) 402 stores data and a program in which a procedure for control by the CPU 401 is stored. The RAM (Random Access Memory) 403 is a memory for storing various parameters used in image processing and a program for executing processing in the information processing apparatus 100 and each unit connected thereto. The RAM 403 stores the control program executed by the CPU 401, and temporarily stores various data for when the CPU 401 executes various control.

The HDD (Hard Disk Drive) 404 is an auxiliary storage apparatus for saving various data such as a series of images. The USB (Universal Serial Bus) 405 is connected to the operation unit 409.

The communication unit 406 is a circuit for performing communication with each unit that configures the information processing system 1. The communication unit 406 may be realized by a plurality of configuration elements to match a desired communication mode.

The GPU (Graphics Processing Unit) board 407 is a general-purpose graphics board that includes a GPU and a video memory. The information processing apparatus 100, by having the GPU board 407, can perform image display or image processing computations at high speed without requiring dedicated hardware. Note that, in the present embodiment, the information processing apparatus 100 does not need to have the GPU board 407 because configuration is such that deformed images and error images are obtained from the data server 150.

The HDMI (registered trademark) (High Definition Multimedia Interface) 408 is connected to the display 410.

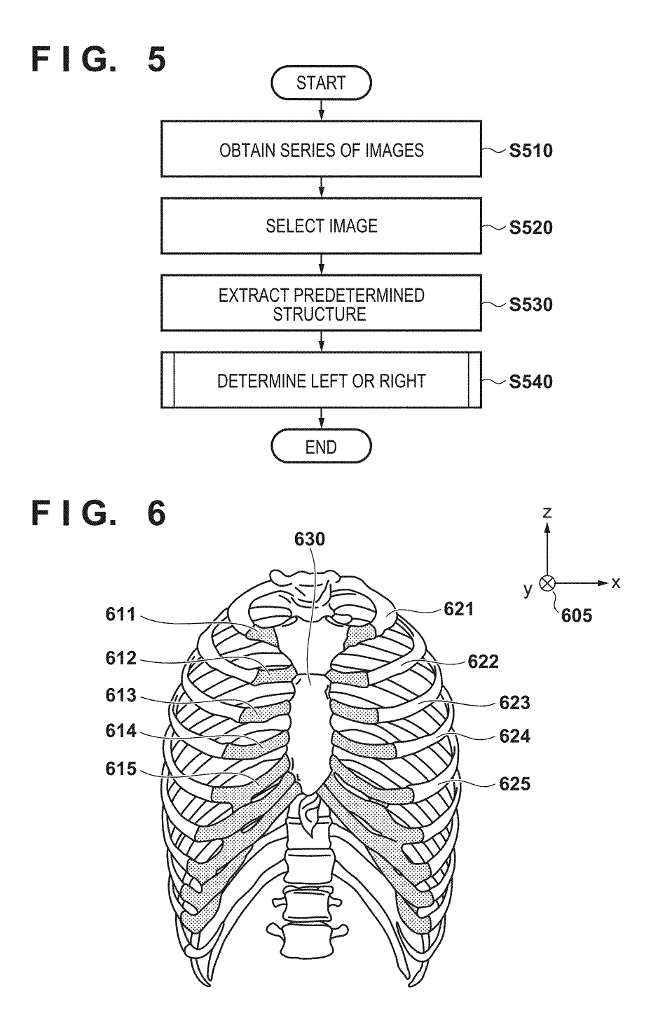

FIG. 5 is a flowchart that illustrates an example of processing that is performed by the information processing apparatus 100. By the processing illustrated in FIG. 5, the information processing apparatus 100 extracts a rib from the series of tomographic images, and, based on the position of the rib in the images, determines a left or right breast (in other words determines whether an imaged region (a structure extracted in the tomographic images) is a left or right breast). Description in detail is given below regarding processing of each step.

In in step S510, the obtaining unit 102 obtains a series of tomographic images of a breast from the data server 150. The obtaining unit 102 then transmits the obtained images to the selection unit 104.

In step S520, the selection unit 104 selects a tomographic image group to use in extraction of a rib from the series of tomographic images of the breast that were obtained in step S510. Below N selected tomographic images are represented as In (1≤n≤N). In the present embodiment, the selection unit 104 selects a tomographic image group of a horizontal section obtained by a longitudinal scan in a downward direction from a top-right of a breast. For example, the selection unit 104 selects a series of tomographic images 300 for a predetermined amount of time (for example, three seconds) after the start of manual scanning of the 1D probe 240. The timing of the start of manual scanning may be a timing when, for example, the 1D probe 240 contacts the skin 201 of the breast 200 and a tomographic image 300 for the inside of the breast starts to be obtained. This timing can be determined by whether a difference between a current tomographic image and a tomographic image for a state where the 1D probe 240 is not in contact with the breast 200 is greater than or equal to a constant, for example. The selection unit 104 then transmits the selected tomographic image group to the analysis unit 106.

In step S530, the analysis unit 106 analyzes the tomographic image group selected in step S320 to extract the position of a rib in each tomographic image. Here, as illustrated in FIG. 3, in an ultrasonic tomographic image 300, a surface 310 of a rib is visualized with a high luminance, and a deep portion 311 thereof is a low luminance. Accordingly, by a publicly known method such as the method recited in Japanese Patent No. 5284132, it is possible to extract the position of the rib. Accordingly, it is assumed that in the present embodiment, similarly to the method recited in Japanese Patent No. 5284132, the analysis unit 106 performs smoothing processing on each tomographic image 300 and then extracts boundary lines between rib regions and intercostal regions by a Sobel filter to thereby extract a position 312 (in other words, a position having the lowest value on the X axis) of a left end and a position 313 (in other words, a position having the highest value on the X axis) of a right end of a rib in each tomographic image. Below, the position of the left end of the rib extracted from a tomographic image In is represented as (posLn_x, posLn_y), and the position of the right end is represented as (posRn_x, posRn_y). The analysis unit 106 then transmits to the determination unit 108 the position of the rib in each tomographic image, in other words the position 312 of the left end and the position 313 of the right end of the rib.

In step S540, the determination unit 108 determines whether the imaged region (the structure extracted in a tomographic image) is the left or right breast based on the position of the rib in each tomographic image extracted in step S530. FIG. 6 illustrates a backbone structure for ribs. As illustrated in FIG. 6, near a breastbone 630, an angle θ5 formed between the X axis of an apparatus coordinate system 605 and a longitudinal direction of a fifth costal cartilage 615 is greater than an angle 82 formed between the X axis and a longitudinal direction of a second costal cartilage 612, for example. Similarly, for an m-th costal cartilage (in the present embodiment 2≤m≤5), as m increases an angle θm formed between the X axis and a longitudinal direction of the m-th rib increases. Meanwhile, near a body side (a side surface of the body), a difference between an angle θ5′ formed between the X axis and a longitudinal direction of a fifth rib 625 and an angle θ2′ formed between the X axis and a longitudinal direction of a second rib 622 is small, for example. Similarly, for an m-th rib (in the present embodiment 2≤m≤5), as m increases an angle θm′ formed between the X axis and a longitudinal direction of the m-th rib is approximately constant. In the present embodiment, the determination unit 108 uses this difference to performed a determination for left or right for a breast.

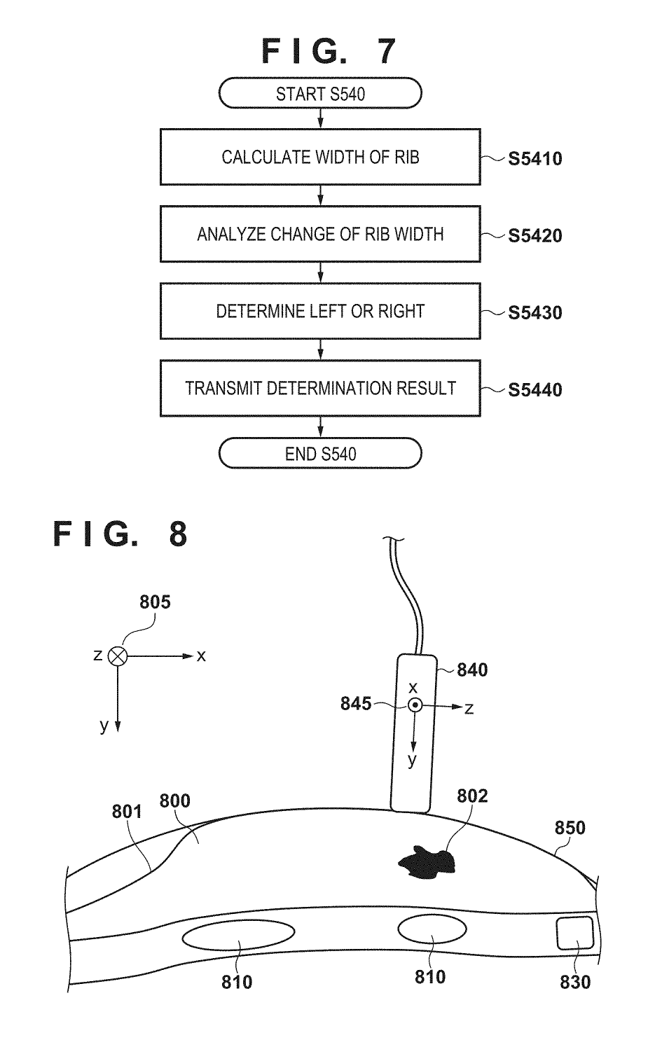

FIG. 7 is a flowchart that illustrates, in more detail, processing performed by the determination unit 108 in step S540.

In step S5410, the determination unit 108 calculates a width Wn of a rib in each tomographic image In in accordance with Equation (1).

$$\begin{matrix} [ EQUATION 1 ] & \\ Wn = \sqrt{{( posRn\_x - posLn\_x )}^{2} + {( posRn\_y - posLn\_y )}^{2}} & ( Equation 1 )\end{matrix}$$

Alternatively, the determination unit 108 may calculate the width Wn of a rib in each a tomographic image In based on only an X coordinate value, in accordance with Equation (2).

[EQUATION 2]

Wn=posRn_x−posLn_x (Equation 2)

In step S5420, the determination unit 108 analyzes change of a width Wn of a rib with respect to change of n. Specifically, the determination unit 108 analyzes the relationship between n and Wn (1≤n≤N) by linear regression, and calculates a value for A in a model of Y=AX+B. As described above, the examiner performs a longitudinal scan in a vertical direction in a horizontal section with a top-right of a breast as an origin, and then performs a transverse scan in a left-and-right direction in a sagittal section with the top-right of the breast as an origin. Accordingly, with reference to FIG. 6, in a case of a left-side breast (a right-side breast of a subject seen from an examiner side), because the second costal cartilage 612, a third costal cartilage 613, a fourth costal cartilage 614, and the fifth costal cartilage 615 are visualized in this order in a tomographic image group In, a width Wn of a rib in the tomographic image group In decreases as n increases. Accordingly, A is a negative value. Meanwhile, in the case of a left-side breast (the right-side breast of a subject seen from the examiner side), the second rib 622, a third rib 623 a fourth rib 624, and the fifth rib 625 are visualized in this order in the tomographic image group In, and thus the width Wn of the ribs is approximately constant. Accordingly, the value of A is approximately 0.

In step S5430, the determination unit 108 performs a determination of whether the breast is on the left or right, based on the value of A calculated in step S5420. For example, if the value of A is smaller than a predetermined negative threshold value, the determination unit 108 determines that the imaged region is a right-side breast, and if the value of A is larger than the predetermined negative threshold value, the determination unit 108 determines that the imaged region is a left-side breast.

In step S5440, the determination unit 108 transmits a result of the determination of whether the breast is on the left or right to the data server 150.

As described above, the information processing apparatus 100 in the first embodiment extracts a predetermined structure from a series of images obtained by scanning an organ of a subject with an imaging device, and determines the organ is on the left or right based on positions in the images. Consequently, it is possible to easily determine whether an imaged region is a left or right organ without depending on a designation by an operator.

Note that the information processing apparatus 100 in the present embodiment extracts a position of a rib in a tomographic image that is imaged by a 1D probe, but limitation is not made to this, and the position of a rib may be extracted after a three-dimensional image is reconstituted from a tomographic image group by a known method. In addition, the information processing apparatus 100 may extract the position of a rib after directly obtaining a three-dimensional image by a two-dimensional array probe (a 2D probe) or the like.

### First Variation of First Embodiment

The selection unit 104 of the information processing apparatus 100 in the first embodiment selects a tomographic image group of a longitudinal scan based on a timing for the start of a manual scan, but the implementation of the present invention is not limited to this. For example, in a case of using a 1D probe to which an azimuth sensor is attached to replace the 1D probe 240, the selection unit 104 may select an image after determining between a longitudinal scan and a transverse scan based on a measurement value of this sensor.

In addition, the timing of the start of a longitudinal scan may be instructed by for example an operator pressing a button (not shown), and a timing for the end of a longitudinal scan may be instructed by for example an operator pressing a button (not shown). The selection unit 104 can select images based on such instructions.

In addition, the selection unit 104 can determine between a longitudinal scan and a transverse scan based on a result of extracting a rib. Here, as illustrated in FIG. 6, an angle formed between the longitudinal direction of a rib and the Y-axis direction is generally larger than an angle formed between the longitudinal direction of the rib and the X-axis direction. Accordingly, the average value of the width of a rib extracted by a longitudinal scan is larger than the average value of the width of a rib extracted by a transverse scan. The selection unit 104 may use this to select a tomographic image group from a longitudinal scan.

By the present variation, it is possible to more reliably determine whether an imaged region is a left or right organ, without being limited to a case where a transverse scan is performed after a longitudinal scan.

### Second Variation of First Embodiment

The information processing apparatus 100 in the first embodiment determines whether an organ is on the left or right based on a tomographic image group obtained by a longitudinal scan, but implementation of the present invention is not limited to this. For example, the information processing apparatus 100 can determine whether an organ is on the left or right based on a tomographic image group obtained by a predetermined scan that is different to a longitudinal scan, such as a transverse scan or a radial scan. In the case of a transverse scan, left or right is determined based on change of a position of a rib in tomographic images instead of change of a width of a rib in tomographic images. It is assumed that a position Pn of a rib in an X axis is calculated in accordance with Equation (3), for example.

[EQUATION 3]

Pn=(posRn_x−posLn_x)/2 (Equation 3)

Here, for example when the probe performs a transverse scan from the right side of one breast toward the left side near the fifth rib 625, in a case of a left-side breast (a right-side breast of a subject seen from an examiner side), as n increases a position Pn on the X axis of the rib in a tomographic image also increases. In contrast, in the case of a right-side breast (a left-side breast of a subject seen from an examiner side), when a transverse scan is performed from a right side of the breast from the examiner side toward the left side, as n increases the position Pn of the rib n a tomographic image decreases. The determination unit 108 can use this relatedness to determine left or right for a breast, similarly to in the first embodiment.

By virtue of the present variation, it is possible to determine whether an imaged region is a left or right organ, without depending on a scanning direction of an imaging device.

### Third Variation of First Embodiment

In the first embodiment, description was given by taking as an example a case of obtaining a tomographic image group that was imaged by the ultrasonic diagnosis apparatus and extracting a rib as a predetermined structure, but the implementation of the present invention is not limited to this. For example, the information processing apparatus 100 may obtain a group of shot images that are imaged by a PAT apparatus, and extract, as a predetermined structure, a blood vessel whose anatomical position is known, such as a lateral thoracic artery for example. Here, because the lateral thoracic artery exists near a side of the body, in the case of obtaining the group of PAT shot images by a manual scan that takes a top-right of the breast as an origin similarly to the ultrasonic tomographic image group, it is possible to determine the left-side breast (a right-side breast of a subject seen from an examiner side) when the lateral thoracic artery is detected in the shot image of a longitudinal scan. In order to extract the lateral thoracic artery, for example the information processing apparatus 100 may learn an image pattern of the artery in advance, and detect by searching for the pattern from among the shot images.

In addition, the information processing apparatus 100 may obtain a tomographic image group of an eye that is imaged by an OCT apparatus, and, by a publicly known method, extract a nerve fiber layer as the predetermined structure, for example. In such a case, the information processing apparatus 100 can determine that an imaged region is a right eye if a right-side nerve fiber layer in a tomographic image is thick.

### Fourth Variation of First Embodiment

In the first embodiment, description is given by taking as an example a case of manually scanning with a 1D probe of an ultrasonic diagnosis apparatus, but implementation of the present invention is not limited to this. For example, configuration may be taken to use a type of ultrasonic diagnosis apparatus that mechanically scans with a 1D probe, or a type of PAT apparatus that mechanically scans with an imaging device.

### Fifth Variation of First Embodiment

In the first embodiment description was given by taking as an example a case of extracting a predetermined structure from a series of images saved on a data server, but implementation of the present invention is not limited to this, and the series of images may be successively obtained from an imaging apparatus without going through a data server. In such a case, it is possible to use the data server 150 in FIG. 1 only for saving a result of a determination of left or right for a breast.

### Second Embodiment

In the first embodiment description is given by taking a case of extracting one type of predetermined structure as an example. The information processing apparatus in the second embodiment extracts a plurality of types of predetermined structures from a series of images obtained by mechanically scanning an organ of a subject with an imaging device, and determining whether the organ is on the left or right based on a positional relationship between the extracted plurality of types of structures (an order of appearance for the plurality of types of structures). In the present embodiment, it is assumed that an operator mechanically scans with a 1D probe of an ultrasonic diagnosis apparatus to image a series of images of a breast, and an information processing apparatus extracts, as the predetermined structures, a sternum and skin that satisfies a predetermined condition from the series of images which are saved on a data server. It is assumed that, in the present embodiment, the predetermined condition represents a condition such that a void is included between a holding member (described later) for the breast and the skin. In addition, in the present embodiment it is assumed that a scanning direction and a position of the 1D probe that is mechanically scanned are measured and known. Description is given below for the information processing apparatus according to the second embodiment, regarding portions that differ from the first embodiment. For portions similar to those of the first embodiment, by invoking the description given above, detailed description is omitted here.

FIG. 8 is a view of a horizontal section that illustrates a situation where an operator mechanically scans with a 1D probe 840 in a negative direction of a Z-axis of a probe coordinate system 845, following a holding member 850 (a member for holding a subject) of a right-side breast 800. In the present embodiment, description is given regarding a case where an inner side (near a breastbone 830) of a breast where a tumor region 802 is present is held so as to be in contact with the holding member 850, so that the tumor region 802 is clearly visualized. In such a case, there is no void between the holding member 850 and skin 801 on an inner side of the breast, and a void is present between the holding member 850 and the skin 801 on an outer side of the breast. It is assumed that a position and posture in an apparatus coordinate system 805 and a shape for the holding member 850 are known, and thus the position of the holding member 850 in each tomographic image is known.

A functional configuration of the information processing apparatus 100 in the second embodiment is similar to FIG. 1 which was described in the first embodiment. However, functions of the analysis unit 106 and the determination unit 108 differ to those in the first embodiment.

The analysis unit 106 analyzes the selected tomographic image group, and extracts skin and a sternum in each tomographic image. In addition, the analysis unit 106 detects the void between the skin and the holding member for the breast, based on a result of extracting the skin.

The determination unit 108 determines left or right for the breast based on a positional relationship between a tomographic image that includes a void between the skin and the holding member for the breast, and a tomographic image that includes a sternum.

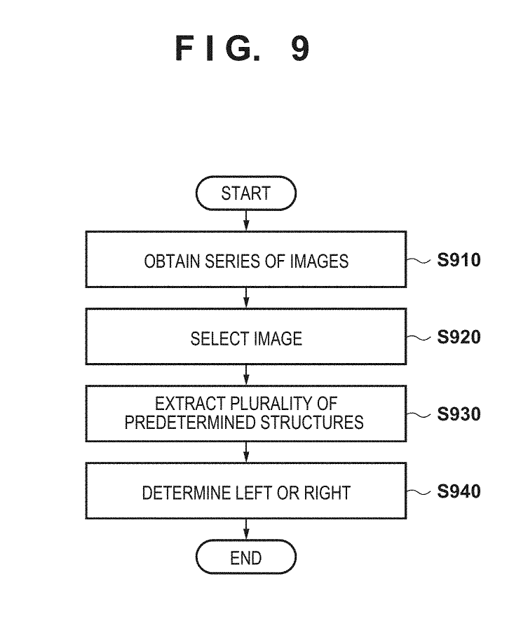

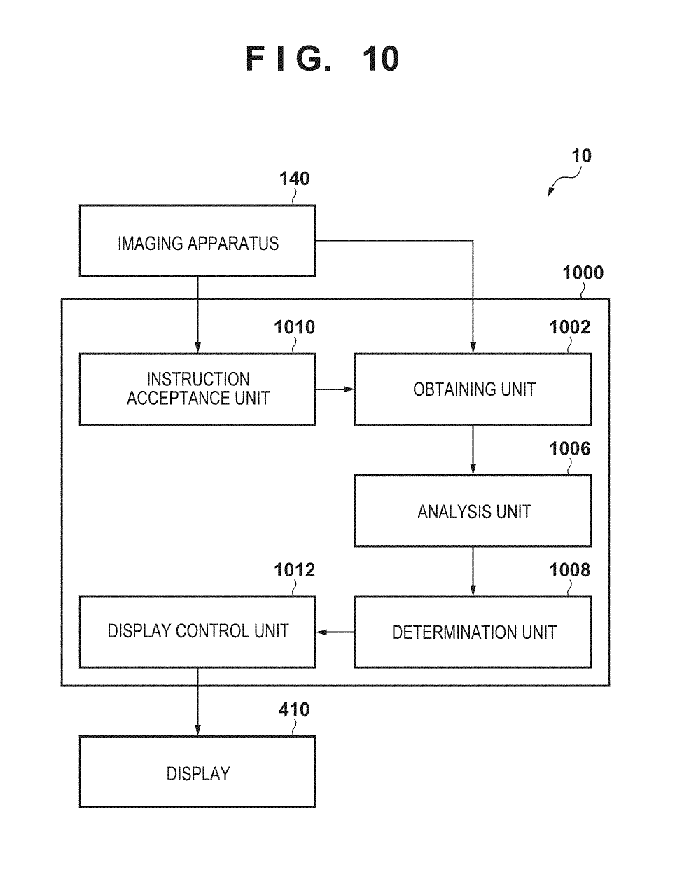

FIG. 9 is a flowchart that illustrates an example of processing that is performed by the information processing apparatus 100. By the processing indicated in FIG. 9, the information processing apparatus 100 extracts the sternum and skin from a series of tomographic images, and determines left or right for the breast based on positions in the images for the sternum and the skin. The processing of step S910 is similar to the processing of step S510 of FIG. 5 which was described in the first embodiment, so description thereof is omitted here.

In step S920, the selection unit 104 selects a tomographic image group to use in a determination of left or right from the series of tomographic images of the breast that were obtained in step S910. In the present embodiment the selection unit 104 selects, based on information of the scanning direction and position of the 1D probe 840 with which the mechanical scan was performed, a tomographic image group for a sagittal section that was subject to a transverse scan in a leftward direction from a top-right of the breast. The selection unit 104 then transmits the selected tomographic image group to the analysis unit 106.

In step S930, the analysis unit 106 analyzes the tomographic image group selected in step S920 to extract the position of the sternum in each tomographic image. Here, if the sternum is present in an ultrasonic tomographic image of the sagittal section, the surface is visualized with high luminance approximately horizontally across the entire region from the left end to the right end of the tomographic image. Accordingly, in the present embodiment, the analysis unit 106 attempts to extract the sternum by a Hough transform with respect to all of the tomographic images In (1≤n≤N). The analysis unit 106 then transmits to the determination unit 108 information relating to the position of the extracted sternum, so as a list of numbers n for tomographic images where extraction of the sternum succeeded (a sternum presence number list).

In addition, the analysis unit 106 analyzes the tomographic image group selected in step S920 to extract the position of skin in each tomographic image. In the present embodiment, the position of the skin is extracted by performing binarization processing with respect to each tomographic image In (1≤n≤N). If the position (Y coordinate value) of the holding member 850 and the position (Y coordinate value) of the extracted skin are difference in a respective tomographic image, it means that there is a void between the holding member and the skin. Accordingly, the analysis unit 106 obtains the numbers n of the tomographic images where a void between the holding member and the skin is present, and transmits to the determination unit 108 information relating to the position of the extracted skin, such as a list of these numbers (a void presence number list).

In step S940, the determination unit 108 determines whether the imaged region is the left or right breast based on information relating to the position of the sternum and skin in all tomographic images extracted in step S930. For example, the determination unit 108 determines that the imaged region is the right-side breast (the left-side breast of the subject seen from an examiner side) if there are more numbers recited in the void presence number list than the numbers recited in the sternum presence number list. In contrast, the determination unit 108 determines that the imaged region is the left-side breast (the right-side breast of the subject seen from an examiner side) if there are fewer numbers recited in the void presence number list than the numbers recited in the sternum presence number list. The determination unit 108 then transmits a result of the determination of whether the breast is on the left or right to the data server 150.

As described above, the information processing apparatus 100 in the second embodiment extracts a plurality of types of predetermined structures from a series of images obtained by scanning an organ of a subject with an imaging device, and determines whether the organ is on the left or right based on a positional relationship for the plurality of types of structures in the images. Consequently, it is possible to easily determine whether an imaged region is a left or right organ without depending on a designation by an operator.

### First Variation of Second Embodiment

Description is given by taking as an example a case where the information processing apparatus 100 in the second embodiment obtains a tomographic image group of a breast that is imaged by an ultrasonic diagnosis apparatus, and extracts the sternum and skin as predetermined structures, but implementation of the present invention is not limited to this. For example, the information processing apparatus 100 may extract a pectoralis minor muscle and the sternum from the tomographic image group of a breast that is imaged by an ultrasonic diagnosis apparatus. In order to extract the pectoralis minor muscle for example the information processing apparatus 100 may learn a pattern of a texture of the pectoralis minor muscle in advance, and extract by searching for the pattern from the tomographic image. Because the pectoralis minor muscle is present only on an outer portion of a breast, the information processing apparatus 100 can determines whether an imaged region is a left or right breast by using a pectoralis minor muscle presence list instead of a void presence list in the present embodiment.

In addition, the information processing apparatus 100 may obtain a tomographic image group for an eye that is imaged by an OCT apparatus, extract, by a publicly known method, an optic papilla, fovea centralis, or the like as predetermined structures, and determine whether the eye is on the left or right based on a positional relationship for these predetermined structures. In such a case, the information processing apparatus 100 can determine that an imaged region is a right eye if the optic papilla is positioned rightward of the fovea centralis.

In addition, the information processing apparatus 100 may obtain a shot image group for a hand or a foot that is imaged by a PAT apparatus, extract a thumb/big toe, a pinky finger/little toe, or the like as predetermined structures by pattern matching or the like, and determine whether an imaged region is a left or right hand or foot based on the positional relationship for these predetermined structures. In such a case, the information processing apparatus 100 can determine that an imaged region is a right hand or foot if the pinky finger/little toe is positioned rightward of the thumb/big toe.

### Third Embodiment

In the first embodiment and the second embodiment, description was given by taking as an example a case of automatically extracting predetermined structures from a series of images that are saved in an external data server. An information processing apparatus in the third embodiment extracts a predetermined structure from an image of an organ of a subject at a predetermined timing, and determines left or right for the organ based on a position in the image for the extracted structure. In the present embodiment, description is given by taking as an example a case where the organ of the subject is a breast, the imaging device for imaging an image thereof is a 1D probe of an ultrasonic diagnosis apparatus, and skin is extracted as a predetermined structure from an image of a timing that is designated by an operator.

Description is given below for the information processing apparatus according to the third embodiment, regarding portions that differ from the first embodiment. For portions similar to those of the first embodiment, by invoking the description given above, detailed description is omitted here.

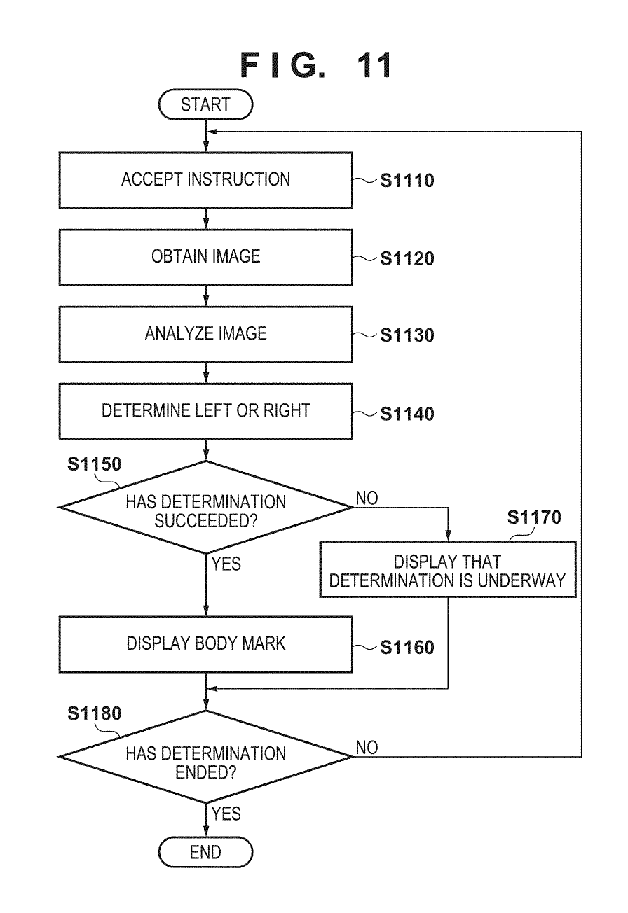

FIG. 10 is a view illustrating an example of a functional configuration of an information processing apparatus in the third embodiment. The information processing apparatus in the third embodiment is an information processing apparatus 1000 which is illustrated in FIG. 10. An information processing system 10 in the third embodiment has the information processing apparatus 1000, the imaging apparatus 140, and the display 410. In the present embodiment, it is assumed that the information processing apparatus 1000 and the display 410 are integrated in an ultrasonic diagnosis apparatus which is the imaging apparatus 140.

The information processing apparatus 1000 has an obtaining unit 1002, an analysis unit 1006, a determination unit 1008, an instruction acceptance unit 1010, and a display control unit 1012. The instruction acceptance unit 1010 accepts an instruction from an operator that relates to a timing for image obtainment, and notifies the obtaining unit 1002 that this instruction has been accepted. The obtaining unit 1002 obtains a tomographic image of the breast at the timing for which the instruction was accepted from the operator. The analysis unit 1006 analyzes the obtained tomographic image, and extracts a position of the predetermined structure (skin in the present embodiment) from the tomographic image. The determination unit 1008 determines left or right for the breast, based on the position of the predetermined structure in each obtained tomographic image. The display control unit 1012 performs control for displaying a result of the determination, a state of the determination as to whether the breast is on the left or right, or the like on the display 410.

FIG. 11 is a flowchart that illustrates an example of processing that is performed by the information processing apparatus 1000. By the processing indicated in FIG. 11, the information processing apparatus 1000 extracts skin from the tomographic image for the timing for which an instruction is accepted from an operator, and determines whether the breast is on the left or right based on the position of the skin in the tomographic image.

In step S1110, the instruction acceptance unit 1010 accepts an instruction from an operator by an operation input with respect to the operation unit 409. In the present embodiment, it is assumed that the operator presses a predetermined button on the operation unit 409 after pressing a left half of the 1D probe so as to contact the skin when they are scanning a left-side breast of a subject (the right-side breast of the subject seen from an examiner side), and conversely presses the predetermined button on the operation unit 409 after pressing so that a right half of the 1D probe contacts the skin when the operator scans a right-side breast of the subject (the left-side breast of the subject seen from the examiner side). That an instruction has been accepted is then notified to the obtaining unit 1002.

In step S1120, the obtaining unit 1002 obtains, from an imaging unit (not shown) of the imaging apparatus 140, a tomographic image of the breast at the timing for which the instruction from the operator was accepted. For example, the obtaining unit 1002 obtains the tomographic image of the breast from the imaging unit (not shown) of the imaging apparatus 140 at a timing when the notification is received from the instruction acceptance unit 1010. The obtaining unit 1002 then transmits the obtained tomographic image to the analysis unit 1006.

In step S1130, the analysis unit 1006 analyzes the tomographic image obtained in step S1120 to extract the position of the skin in the tomographic image. Here, a region where the 1D probe is in contact with skin is visualized with a higher luminance in the tomographic image than a region with no contact. Using this, the analysis unit 1006 obtains an X coordinate value posL_x for a position of a left end where the 1D probe is in contact with skin in the tomographic image, and an X coordinate value posR_x for a position of the right end, in the ultrasonic wave coordinate system 245. The analysis unit 1006 then transmits the position of the skin in the tomographic image, in other words the position of the left end and the position of the right end where the 1D probe is in contact with the skin, to the determination unit 1008.

In step S1140, the determination unit 1008 determines whether the imaged region is the left or right breast based on the position of the skin in the tomographic image that was extracted in step S1130. For example, if the position posL_x of the left end approximately matches the position of the left end of the tomographic image and the position posR_x of the right end does not approximately match the position of the right end of the tomographic image, the determination unit 1008 determines that the imaged region is a left-side breast (a right-side breast of the subject seen from an examiner side). In contrast, if the position posR_x of the right end approximately matches the position of the right end of the tomographic image and the position posL_x of the left end does not approximately match the position of the left end of the tomographic image, the determination unit 1008 determines that the imaged region is a right-side breast (a left-side breast of the subject seen from an examiner side). In other cases, the determination unit 1008 may determine that the determining has failed.

In step S1150, the information processing apparatus 1000 determines whether the determination in step S1140 of left or right of the breast succeeded. The information processing apparatus 1000 advances the processing to step S1160 upon determining that the determination for left or right succeeded (Yes in step S1150). Meanwhile, the information processing apparatus 1000 advances the processing to step S1170 upon determining that the determination for left or right failed (No in step S1150).

In step S1160, the display control unit 1012 displays on the display 410 a body mark for a left-side breast when the left-side breast is determined in step S1140, and displays on the display 410 a body mark for a right-side breast when the right-side breast is determined. Processing then advances to step S1180.

In step S1170, the display control unit 1012 displays information indicating a state where left or right could not be determined on the display 410. For example, the display control unit 1012 performs a display such as “unknown” or “determining” on the display 410. Processing then advances to step S1180.

In step S1180, the information processing apparatus 1000 performs a determination as to whether to end processing for the left or right determination. For example, the information processing apparatus 1000 obtains an instruction to end processing in accordance with an operation input with respect to the operation unit 409 by an operator. The information processing apparatus 1000 causes the processing of the information processing apparatus 1000 to end upon determining to end the processing for a left or right determination (Yes in step S1180). Meanwhile, when it does not determine to end processing for the left or right determination (No in step S1180), the processing of step S1110 is returned to.

As described above, the information processing apparatus 1000 in the third embodiment extracts a predetermined structure from an image of an organ of a subject at a predetermined timing, and determines whether the organ is on the left or right based on a position of the extracted structure in the image. Consequently, it is possible to easily determine whether an imaged region is a left or right organ based on one tomographic image.

### First Variation of Third Embodiment

In the third embodiment, description is given by taking as an example a case where the instruction acceptance unit 1010 accepts an instruction from an operator in accordance with an operation input with respect to the operation unit 409. Limitation is not made to this, and the instruction acceptance unit 1010 may accept an instruction from an operator in accordance with detecting, by moving image analysis or the like, that the operator has caused the 1D probe to be stationary for a predetermined amount of time.

### Second Variation of Third Embodiment

In the third embodiment, description is given by taking as an example a case of processing a still image at a predetermined timing. Limitation is not made to this, and the information processing apparatus 1000 may process a moving image at a predetermined timing. For example, the information processing apparatus 1000 may accept an instruction to start obtaining a moving image and an instruction to stop obtaining the moving image, and determine whether an organ is on the left or right after performing the image processing described in the first embodiment with respect to the moving image (tomographic image group) obtained for the period between the start instruction and the end instruction.

### Other Embodiments

Description was given above for several embodiments of the present invention by examples where an ultrasonic diagnosis apparatus, a PAT apparatus, and an OCT apparatus are used, but application range of the present invention is not limited to these. For example, the present invention can be applied to any apparatus that analyzes one or more images obtained by imaging an organ of a subject and determines whether the organ is on the left or right. For example, the left or right determination method of the present invention may be applied to one or more images obtained by a diffuse optical tomography (DOT) apparatus or the like.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-087591, filed Apr. 26, 2017, which is hereby incorporated by reference herein in its entirety.

What is claimed is:

1. An information processing apparatus, comprising:
an obtaining unit configured to obtain one or more images that are imaged by scanning region of a subject with an imaging device;
an analysis unit configured to analyze the obtained one or more images to extract a predetermined structure; and
a determination unit configured to determine whether the region is on the left or right of the subject based on information relating to a shape or position of the extracted structure in the obtained one or more images.

2. The information processing apparatus according to claim 1, wherein the determination unit determines whether the region is on the left or right of the subject based on a change of the shape or position of the extracted structure in the obtained one or more images.

3. The information processing apparatus according to claim 1, wherein
the region is a breast and the predetermined structure is a rib, and
the determination unit determines whether the region is on the left or right of the subject based on change of a width of the rib in the obtained one or more images.

4. The information processing apparatus according to claim 1, wherein
the region is a breast and the predetermined structure is a predetermined blood vessel, and
the determination unit determines whether the region is on the left or right of the subject based on change of a position of the blood vessel in the obtained one or more images.

5. The information processing apparatus according to claim 1, wherein
the analysis unit extracts a plurality of predetermined structures in the region, and
the determination unit determines whether the region is on the left or right of the subject based on a positional relationship of the extracted structures in the obtained one or more images.

6. The information processing apparatus according to claim 5, wherein the positional relationship of the extracted structures is an order of appearance of each of the extracted structures in the obtained one or more images.

7. The information processing apparatus according to claim 5, wherein
the region is a breast, and the predetermined plurality of structures is a sternum and skin that satisfies a predetermined condition, and
the determination unit determines whether the breast is on the left or right of the subject based on a positional relationship between the sternum and the skin that satisfies the predetermined condition, in the obtained one or more images.

8. The information processing apparatus according to claim 5, wherein
the region is a breast and the predetermined plurality of structures is a sternum and a pectoralis minor muscle, and
the determination unit determines whether the breast is on the left or right of the subject based on a positional relationship between the sternum and the pectoralis minor muscle in the obtained one or more images.

9. The information processing apparatus according to claim 1,
further comprising an instruction acceptance unit configured to accept an instruction for execution of obtainment of the one or more images,
wherein the obtaining unit obtains the one or more images based on the instruction.

10. The information processing apparatus according to claim 1, wherein, for the imaging device, scanning is controlled by an operator or an external apparatus.

11. The information processing apparatus according to claim 1, wherein the obtaining unit obtains the one or more images that are saved on an external server.

12. An information processing method, comprising:
obtaining one or more images that are imaged by scanning a region of a subject with an imaging device;
analyzing the obtained one or more images to extract a predetermined structure; and
determining whether the region is on the left or right of the subject based on information relating to a shape or position of the extracted structure in the obtained one or more images.

13. A non-transitory computer-readable storage medium storing a computer program for causing a computer to execute an information processing method, the method comprising:
obtaining one or more images that are imaged by scanning a region of a subject with an imaging device;
analyzing the obtained one or more images to extract a predetermined structure; and
determining whether the region is on the left or right of the subject based on information relating to a shape or position of the extracted structure in the obtained one or more images.
